(19) United States
(12) Patent Application Publication
(10) Pub. No.: US 2012/0234746 A1
(43) Pub. Date: Sep. 20, 2012

(54) FILTER BLOOD FLUID CHANNEL METHODS, DEVICES, AND SYSTEMS

(76) Inventors: John Howard, Salem, MA (US); Edward F. Leonard, Bronxville, NY (US); Thomas Qin, New York, NY (US)

(21) Appl. No.: 13/496,084

(22) PCT Filed: Sep. 14, 2010
(86) PCT No.: PCT/US10/48788

§ 371 Date: Jun. 6, 2012

Related U.S. Application Data
(60) Provisional application No. 61/242,322, filed on Sep. 14, 2009.
(60) Provisional application No. 61/242,861, filed on Sep. 16, 2009.
(60) Provisional application No. 61/301,127, filed on Feb. 3, 2010.

(51) Int. Cl. B01D 63/06

(52) U.S. Cl. 210/321.89

(57) ABSTRACT

A risk of thrombogenesis is minimized in a tubular fiber membrane filter by flowing blood or other fluid through a header manifold that ensures a minimum shear rate on the wetted surfaces without flow reversal, stagnation volumes, or a shear rate that is too high. In an embodiment, fluid is conveyed into a header space and into a manifold face at a perimeter of the header space. The header space has a progressively decreasing clearance that is minimal to provide for substantial shear rate and decreasing toward a minimum clearance in a region that is remote from the perimeter and vented by openings to the microtubular membrane fibers. Other features and embodiments are described.

### CROSS-REFERENCE TO RELATED APPLICATIONS

The present application claims the benefit of U.S. Provisional Application Nos. 61/242,322, filed on Sep. 14, 2009; 61/242,861, filed on Sep. 16, 2009; and 61/301,127, filed on Feb. 3, 2010, the contents of which are incorporated herein by reference in their entireties.

### BACKGROUND

Patients with acute or chronic renal failure suffer from the effects of natural toxins in the blood and/or fluid overload. Renal replacement therapy for these patients involves extracorporeal blood treatment, such as dialysis to remove the toxins or ultrafiltration to remove excess fluids. In the various forms of renal replacement therapy, a hemofilter or dialyzer is used which contains a plurality of semi-permeable hollow membrane filter fibers dividing the unit into flow channels. Blood is pumped across one side of the membrane and a dialysis solution across the other side (in the case of dialysis), or blood is pumped across one side of the membrane and excess fluid passes across to the other side (in the case of ultrafiltration). Impurities and/or excess fluid pass through the walls of the membrane by diffusion, convection, and or a combination of these processes. Other blood fluids or fluids containing blood components may be passed along a membrane as well, for example, as described in U.S. Pat. No. 7,588,550 to Leonard, et al (currently publication US2008/0009780), which is hereby incorporated by reference in the regular patent application and attached to this application as an appendix in the provisional stage.

Conventional dialyzers use a large number of microfibers in a chamber that carries the blood, or other blood fluid or fluids. Thousands of hollow semipermeable filter fibers convey blood or other blood fluid or fluids between end caps on the chamber, each of which is accessed with a port. There are one or more other ports for conveying dialysate through the chamber or filtrate may simply be drawn from the chamber, depending on the treatment.

In medical treatment devices such as dialysis machines, blood or blood fluid is conveyed through tubes and filters having various blood channels whose shapes and sizes vary with various flow characteristics. It is believed that blood should not remain stagnant for periods of time in such systems, so generally they are designed to keep blood moving and prevent blood from pooling. However, some parts of blood systems pose particular challenges, for example the transitions in the headers of dialyzers and hemofilters, for example, where stagnant zones are hard to avoid. Conditions such as the materials of which blood conveying systems are made and other factors are also believed play a role in blood coagulation in artificial blood channels.

To prevent blood from coagulating, anticoagulants such as heparin are used. The use of such agents is disfavored and there is a need in the art for improved ways of designing blood conveying devices which help to reduce coagulation and thereby provide the potential to reduce the need for anticoagulants.

### SUMMARY

A risk of thrombogenesis is minimized in a tubular fiber membrane filter by flowing blood or other fluid through a header manifold that ensures a minimum shear rate on the wetted surfaces without flow reversal, stagnation volumes, or a shear rate that is too high. In an embodiment, fluid is conveyed into a header space and into a manifold face at a perimeter of the header space. The header space has a progressively decreasing clearance that is minimal to provide for substantial shear rate and decreasing toward a minimum clearance in a region that is remote from the perimeter and vented by openings to the microtubular membrane fibers. Other features and embodiments are described.

These and other features and advantages of the disclosed embodiments are described in or are apparent from the following detailed description of structures, apparatus, systems, and method.

### BRIEF DESCRIPTION OF DRAWINGS

Various exemplary embodiments of this invention will be described in detail, with reference to the following figures, wherein:

FIG. 1A shows schematically the flow of blood in a cap for a microtubular filter fiber type of filter device, according to embodiments of the disclosed subject matter.

FIG. 1B is a figurative illustration of a microtubular filter fiber type of filter device with caps according to embodiments of the disclosed subject matter.

FIGS. 1C and 1D show alternative configurations of the embodiments of FIGS. 1A and 1B.

FIG. 1E illustrates features of a filter end cap according to embodiments of the disclosed subject matter.

FIG. 1F illustrates a prior art filter end cap.

FIG. 2 illustrates a cap conforming to the schematic of FIG. 1A in cross section.

FIG. 3 illustrates another cap conforming to the schematic of FIG. 1A in cross section.

FIGS. 4A through 4C illustrate a cap conforming to the schematic of FIG. 1A and approximately to the embodiment of FIG. 2.

FIG. 5 illustrates one of a variety of variations on a cap for a microtubular filter fiber type of filter device, according to embodiments of the disclosed subject matter.

FIGS. 6A and 6B show a filter cap embodiment according to other alternative embodiments of the disclosed subject matter where an axial inlet is provided.

FIG. 6C illustrates a flexible membrane feature that may be employed with suitable ones of the embodiments disclosed.

FIGS. 7A through 7C show, figuratively, a tapered header with a bypass channel and a gutter.

FIG. 8 shows a blood treatment system with a filter having any of the header configurations according to the disclosed subject matter.

FIG. 9 shows an approximation used for CFD computations of a filter manifold with a large number of microtubular membrane filters.

FIGS. 10A through 10G illustrated various examples of end cap configurations and results of computational and experimental testing and evaluation.

Throughout the Figures, the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION OF DRAWINGS AND EMBODIMENTS

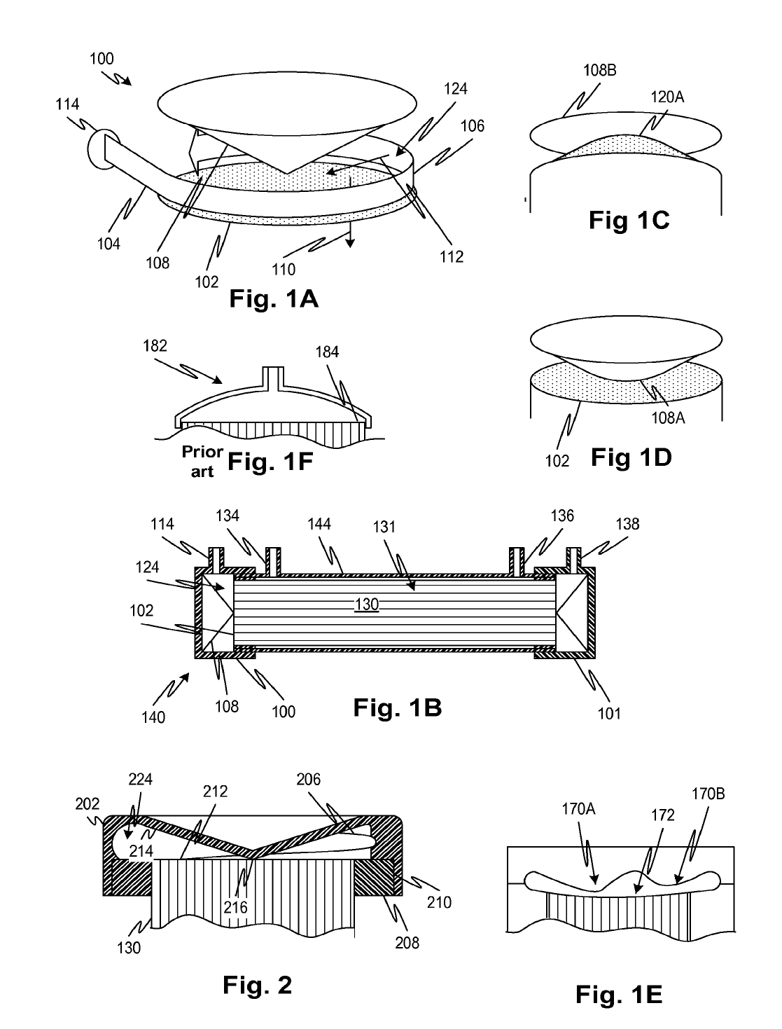

Referring to FIGS. 1A and 1B, a cap 100 for a microtubular membrane type filter 140 receives blood through a port 114 and distributes the blood to a bundle of microtubular membranes 130 through the face of a header 102. Blood may be received in the port 114 so as to be distributed around the perimeter of a plenum 124. The plenum 124 may be tapered toward a center of the header face 102 where the blood enters the internal lumens of the microtubular fiber filters 130. By ultrafiltration, diafiltration, hemofiltration, dialysis or any other mechanism, species are transported across the microtubular fiber filters 130 into a filtrate space 131, which is contained in a filter body 144, and out through an outlet port 134. After blood passes through the microtubular fiber filters 130, it is collected in an outlet cap 101 where it exits through a port 138. In dialysis applications, a port for the supply of fresh dialysate 136 may be provided. Fresh dialysate after the exchange of species, thereby transformed into spent dialysate may exit the port 134.

Blood entering the inlet port 114 may circulate around a perimeter of a plenum 124 so that the blood may be conveyed uniformly about the perimeter of the plenum 124 and thereby flow toward the center of the plenum 124 as indicated by arrow 112. The space is defined between a cone shaped face 108 and the header face 102. Arrow 112 showing only an infinitesimal “spoke” of the entire radial flow which surrounds the space. The plenum 124 may be tapered by the cone shaped face 108 that intrudes into the plenum 124. The tapering of the spaced may help to force blood equally among the microtubular fiber filters 130 as indicated by arrow 110. Arrow 110 illustrates a downward flow through one of many fibers entering the fiber through the header face 102. The flow 104 around the plenum 124 may begin as a tangential flow which is directed in a circular flow 106 by a suitably shaped circumferential channel that opens to the plenum 124 along a side thereof. The flow may also simply open to the plenum 124 and be directed by a perimeter wall partly defining radial boundary of the plenum 124. The channel or perimeter boundary of the plenum 124 is not shown in FIG. 1A to illustrate the flow, but a variety of configurations may be provided. Several are discussed below.

Note that the illustrations in the current application have exaggerated features, such as a perimeter plenum and header clearance and in actual embodiments, the variation in header clearance may be substantially less.

Referring now to FIG. 2, a cap 202 has a substantially toroidal plenum 224 defined between a header face 212 and a cone shaped face 214. A channel 224 is defined around a perimeter of the plenum 224. The channel 224 narrows progressively around the perimeter of the plenum 224 as indicated by the narrowing portion 206. A flow of blood is introduced in the channel 224 and flows in a direction in which the channel size diminishes to a near zero size. Blood flows radially from the channel 224, 206 toward the apex 216 of the cone shaped face 214, with portions of the radial flow stemming into the filter fibers 130.

In the above and other embodiments, the shape of the header may be determined by any suitable mechanism to ensure as uniform, and limited in a target range, a shear rate distribution across all wetted surfaces as possible. This may be accomplished by computationally by an optimization scheme using assumed constraints or by experimental trial and error or by any other suitable means. One mechanism based on trial and error may employ real blood or other fluid susceptible to coagulation or thrombogenesis. The fluid may be pumped through various headers for a period of time and the various header designs scored based on the associated incidence of the undesired effects of thrombosis, flow stagnation, and/or other effects.

The result of optimization, no matter how wide in scope, may he a variety of different header shapes. For example, as shown in FIG. 1C, the manifold face may form a conical surface that reduces the clearance of the header near the center. In another embodiment, both the manifold face and the opposing header face may be convex or concave to produce the same effect of a reduced clearance near the center or preferably at least away from the perimeter of the header. In other embodiments, the shape of the convex surfaces may be curved rather than having a sharp apex as illustrated in FIGS. 1A and 2. Also, as illustrated in FIG. 1E, a suitable configuration may have one or more minimum, or near-minimum clearance points. Note that besides the header shape, the position and shape of the entry may also be optimized. There may be more than one inlet as well.

Although the discussion herein is mostly concerned with inlet header, the embodiments also include the designs for outlet headers as well. That is, non-thrombogenic outlet header configuration may be obtained by optimizing for a target shear rate with minimal variation across all wetted surfaces. The above features are combined with the feature of a minimum flow such as at a point of minimum clearance height occupies a minimum total area, for example, located at a point (e.g., 170A and 170B) rather than along a blind perimeter 184 as in typical prior art dialyzer headers as shown in FIG. 1F. Two additional features are included in the disclosed subject matter, namely, a bracketed range of shear rate across the wetted surfaces of the header space which encapsulates a minimum flow (and thereby avoidance of stagnation) throughout as well as avoidance of flow separation which may also induce thrombosis or other undesired effects for a biological fluid such as blood plasma or whole blood.

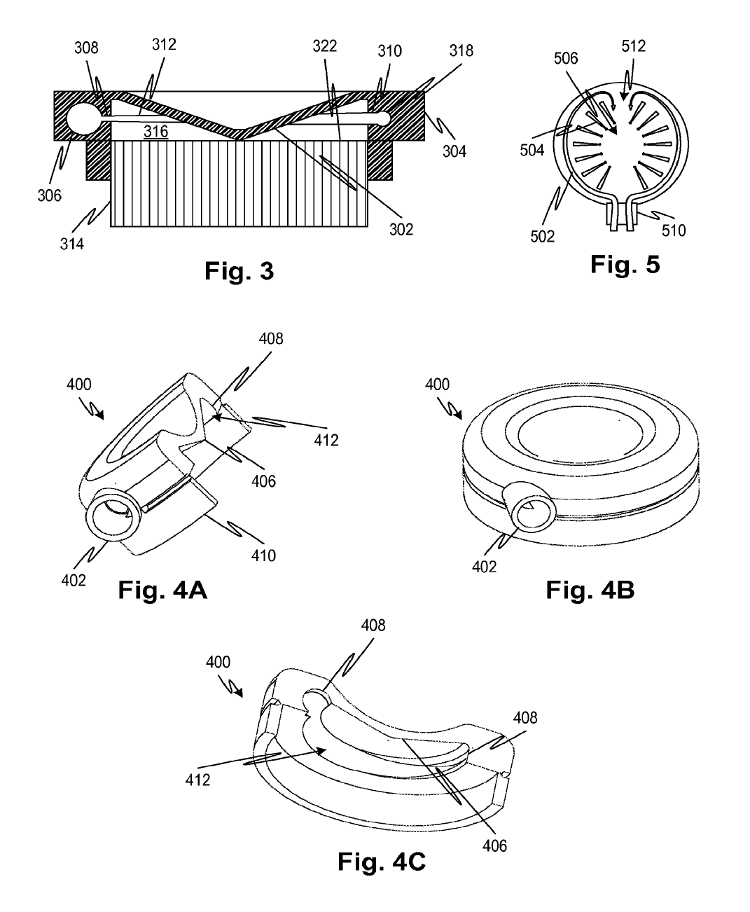

Referring now to FIG. 3, a proximal channel portion 306 leads progressively to a smaller distal channel portion 318. The channel 306, 318 feeds a flow of blood into a plenum 316 through a continuous slit having proximal 308 and distal 310 portions, the slit becoming larger toward a distal end thereof. The channel 306, 318 and slit 308, 310 are configured to provide a substantially uniform rate of flow into the plenum 316. Blood may be introduced into the proximal channel portion 306 and may enter the plenum 316 along the slit 308, 310, thereafter leaving the plenum, which is tapered due to a conical face 302 through a header face 322.

FIGS. 4A through 4C show various three-dimensional views of a cap 400 according to embodiments of the disclosed subject matter. The inlet port 402 leads to a tapered perimeter channel 408 opening to a tapered plenum 412 with a conical surface 406. Note that FIGS. 4A and 4C shows sections taken in different, perpendicular, planes. Referring to FIG. 5, the flow of blood or other fluid may be bidirectional so that blood is introduced radially and flows circumferentially 502 in opposite directions until it enters the plenum 506 where it flows radially 504. The blood finally passes through a header face 512 as in the other embodiments described herein. In another variation which is not depicted, a circumferential channel is located above the plenum. In such a variation, flow from the channel may be provided through a slit opening to the plenum. Such an alternative channel may also be tapered.

Note that in variations of the foregoing and further embodiments, a plenum may be formed which has tapering provided by other configurations, including opposing conical faces (e.g., the header face may be conical). The tapering may correspond to a different shape from a cone also, for example, the face or faces defining the plenum may be curvilinear surfaces such as spheroidal shapes or complex shapes with multiple bulges including minimum heights that are not central but offset from the center (See FIG. 1E). The surfaces may be shaped according to experiment or simulation (e.g., computational fluid dynamical; CFD simulations) to be optimized for a minimum (and maximum) fluid shear rate and minimum mean velocity (though velocity may be subsumed by a constrained shear requirement) at all points throughout the wetted surfaces of the cap and manifold. As stated, the channels may be optimized to provide a target shear rate range at all points throughout the moving fluid (blood, blood fluid or other fluid) volume under the predicted flow rate and other predetermined conditions.

One of the functions of the inward-radial flow is to provide non-zero flow over all parts of the header face. In prior art devices where flow is generally radially outward, a larger perimeter of the plenum space is, essentially, a blind end of a channel. As such, the flow to a large area may be stagnant. In the present system, substantially all portions of the flow may be non-zero and substantial and perhaps only a vanishingly small area, if at all, of the header face in the middle may be associated with a near zero flow condition. Also, the height of the header space is varied to ensure that fluid moves with a minimum shear rate over all, or substantially all, wetted surfaces and the channel height combined with the effective channel trajectory may simultaneously ensure the minimum shear rate. For example, a suitable and practicable minimum may be in the range of about 250 sec⁻¹. Note that any minimum shear rate areas can be reduced to a small area by providing that the minimum height coincides with an area of the manifold surface to permit blood to escape and a flow toward that small area. In any of the present embodiments, the rate of flow may be varied deliberately to take advantage of momentum effects that can move the point or points of minimum shear rate. In such embodiments, the pump may be regularly pulsed or varied in speed to cause the shear rate pattern to shift such that all wetted surfaces, even areas of minimum shear rate at one time, experience an elevated shear rate at other times (i.e., other times of a flow rate variation cycle).

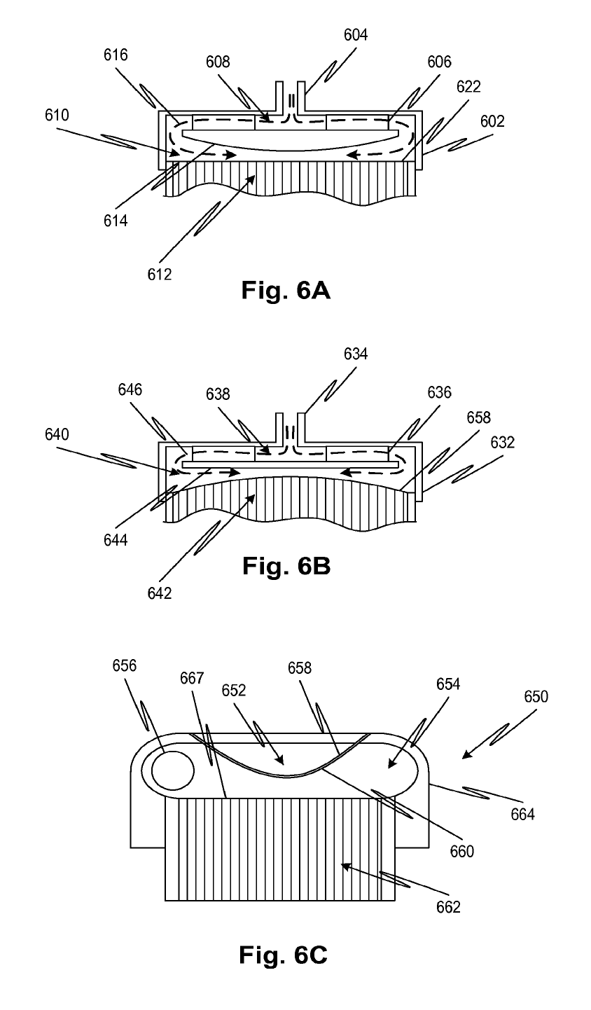

Any of the embodiments disclosed herein can be modified by the inclusion or replacement of a portion of a wetted wall by a flexible membrane 658 as illustrated in FIG. 6C, which shows a filter cap 650. The flexible membrane 658 presents a flexible surface 660 that can yield and conform responsively to static and/or dynamic pressure within the head space 654. Fluid flows through an inlet (or outlet) 656 to communicate with a perimeter portion of the head space 654. A space 652 may be open to atmosphere or closed and may rely on compression of gas or simply the mechanical characteristics of the membrane wall 660 to provide a shape-memory as desired. As in the other embodiments, the fluid flows through a filter fiber bundle 662 that communicates through a manifold face 667 to the head space 654. In any of the embodiments, the flexible membrane may be of any suitable polymer or composite material.

Referring now to FIG. 6A, a filter cap 602 has an axial inlet 604 through which blood or other fluid flows through a channel 608 which may have radial guides 606. The flow, indicated by arrows 616 is directed to a perimeter region of a header space 610 and flows toward and into an inlet manifold surface 622 and into filter fibers 612. A convex surface 614 causes the space between the surface 614 and the manifold surface 622 to decrease progressively toward the axial center, thereby helping to maintain minimum shear rate while eliminating any large regions of stagnant flow. A variant of this concept of FIG. 6A is shown in FIG. 6B where the manifold surface 658 is convex creating the progressively decreasing gap between itself and the opposing surface 644 creating a progressively decreasing height of the channel 640. Here, the filter cap 632 has an axial inlet 634 through which blood or other fluid flows through a channel 638 which may have radial guides 636. The flow, indicated by arrows 646 is directed to a perimeter region of the header space 640 and flows toward and into the inlet manifold surface 658 and into filter fibers 642.

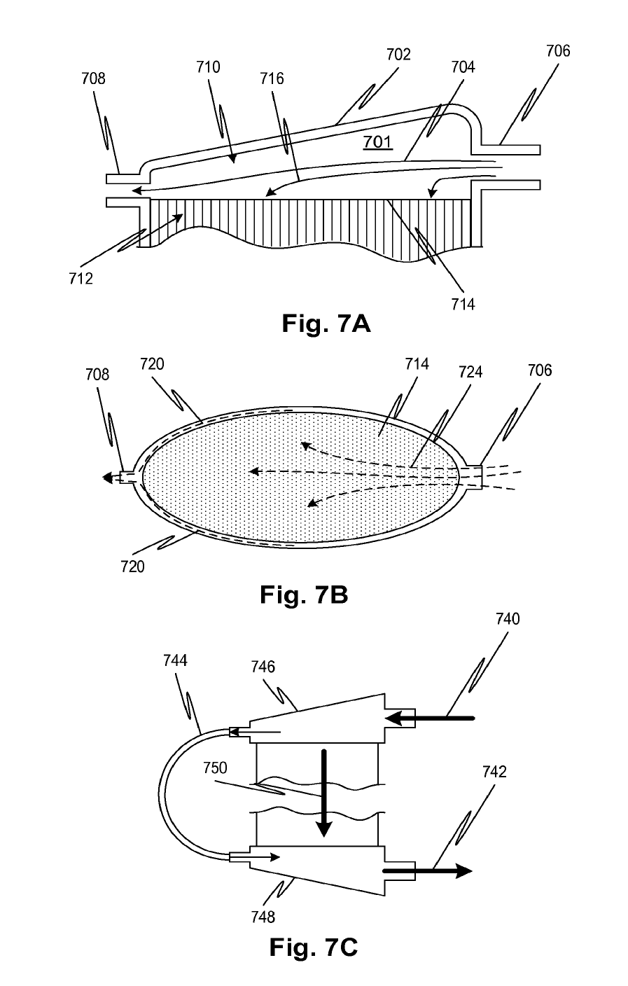

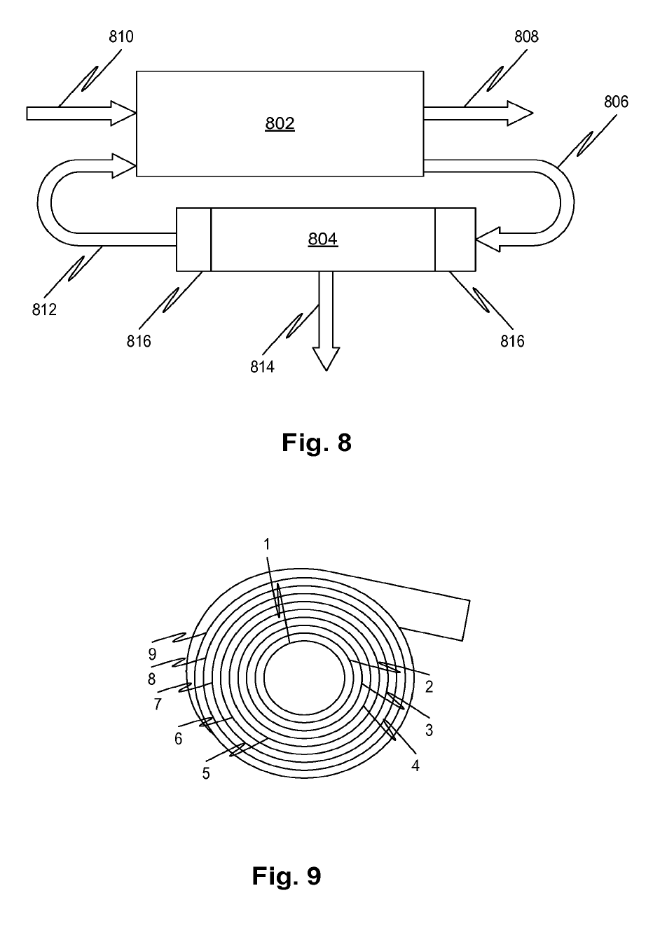

Referring now to FIGS. 7A and 7B, a filter header 702 has an inlet 706 leading to a head space 701 whose clearance height decreases progressively toward a bypass outlet 708. Fluid flows into the head space as indicated by the arrows 716, and through the manifold surface 714 into the filter fibers 712. A portion of the flow 704 continues to the bypass outlet. This flow includes flow collected from a gutter region 720 which incorporates flow in a radial direction toward the gutter as indicated by arrow 724. The bypass flow toward and into the gutter eliminates the blind end stagnation associated with the configuration of FIG. 1F discussed above. The head space can have any of a variety of different shapes—what is shown is merely illustrative of a shape that, in correct dimensions and aspect ratio would force most of the flow into the manifold surface 714 and through the filter fibers and only require a small bypass flow to ensure no stagnation arises. FIG. 7C shows a filter module with a bypass line 744 which receives the bypass flow from an inlet cap 745 and provides it to a mirror-image outlet cap 748. The incoming whole fluid is indicated at 740 and the outgoing fluid after processing (flow indicated at 750) by the filter is indicated at 742. In embodiments, the bypass line 744 may be incorporated in the body of the filter.

Note also that although the disclosed embodiments have focused on blood applications, the features of the disclosed embodiments may be applied to other types of fluids in applications other than medical treatments. The benefits of the disclosed embodiments include a design that is compatible with maintaining a minimum shear rate at all points in a flow and concomitantly in which no stagnant regions of flow may occur. Fluid outlets in a plenum space may be channels other than filter fibers in such applications. There are evident benefits for application to shear-thinning fluids.

Note that a blood fluid, such as plasma, conveyed through an extracorporeal blood circuit may cause activation of the blood when the conveyed blood fluid comes into contact with the blood. Thus coagulation does not need to occur in the extracorporeal circuit itself to present a problem. In any of the foregoing embodiments, a blood fluid or any fluid that may be altered so as to create a risk of coagulation in some fashion by flowing through an artificial fluid circuit, or any fluid that comes in contact with blood with may be so altered or any shear-thinning fluid may be usefully conveyed through the disclosed system.

In a method, blood plasma is removed from a patient by means of a membraneless separation device. The plasma is ultrafiltered in a dialyzer or hemofilter using a caps according to any of the embodiments described herein. The plasma is returned to the membraneless channel.

In another method, conventional dialysis, hemofiltration, hemodiafiltration, or other blood treatment such as apheresis or oxygenation is performed using a filter having at least an inlet cap configured according to any of the embodiments described above.

Although the disclosed subject matter has been described with preferred embodiments, it is to be understood that modifications and variations may be resorted to, without departing from the spirit and scope of this invention, as those skilled in the art will readily understand. Such modifications and variations are considered to be within the purview and scope of the disclosed subject matter.

Flow separation, in which fluids detach from boundary layers and rotate in eddies and vortices, and effectively becomes stagnant, are believed to be a stimulus to clot formation. Computational fluid dynamics (CFD) may be used to optimize the end-cap regions of the filter or dialyzer according to embodiments of the disclosed subject matter. According to a model of the end cap, the end cap region receives flowing blood plasma or blood which suddenly encounters a resistive “wall” with, for example, thousands of fiber openings. According to the model, the pressure drop may be constant along each fiber and large compared to any pressure fluctuations in the end cap. The optimization goal may be defined as to achieve approximately uniform shear rate (that is, shear within a predefined range) conditions over the end-cap wetted surfaces (or most of the surfaces) and prevent separated flows anywhere in the fluid volume of each end-cap. According to a method, an end-cap and its inlet according to the disclosed embodiments is optimized using CFD software to predict areas of separated flow and, ultimately, thrombosis and the dimensions of the end cap and inlet are modified to approach the optimum configuration.

FIG. 8 shows shown a schematic of a two-unit conceptual artificial kidney consisting of blood plasma separation module (BPSM) 802 and mini-dialyzer (or ultrafilter) 804. Arrow 810 shows incoming blood and 808 blood that has been dewatered and/or cleansed by means of the mini-dialyzer or ultrafilter 804. Plasma 806 separated by the BPSM 802 flows into a cap 816 through filter fibers and ultrafiltrate is removed as indicated by arrow 814. dewatered plasma 812 returns to the BPSM 802 or in embodiments is mixed with fresh blood 810 before flowing into the BPSM 802. In a dialyzer embodiment of mini-dialyzer or ultrafilter 804, fresh dialysate would flow into the mini-dialyzer and 814 would indicate spent dialysate.

In a typical dialyzer used in hemodialysis treatments, unfiltered plasma is pumped into tubular membrane fibers through an end-cap that forms a header space distributing. As it approaches the fiber bundle face, it encounters a resistive wall of fibers. Dialysate enters flows concurrently into the dialyzer body and removes waste and excess water from plasma via concentration gradients. Filtered plasma is then re-circulated.

Suitable software packages for CFD include Star-CCM+ v. 3.02.11 by CD-Adapco® and SolidWorks 2009 Student Edition by Dassault Systèmes SolidWorks Corp. SolidWorks is a computer-aided design (CAD) package that allows the user to effectively render a three-dimensional representation of a conceptual model. This model can then be imported into StarCCM+, the CFD package used for numerical simulations. Star-CCM+ simulates flow problems by solving one or more of three conservation equations simultaneously in order to generate a numerical solution. Each equation has the form:

$$\frac{\partial }{\partial t} \int \int {\int }_{V} ρφ d V + \int {\int }_{S} ρφ \vec{u} d \vec{A} = \int {\int }_{S} {Γ}_{φ} \vec{∇} φ d \vec{A} + \int \int {\int }_{V} S d V \qquad [ 1 ]$$

where ρ is fluid density, Γ_{φ} is the diffusive flux term, u is the velocity vector, dA is the differential area vector, and dV is the control volume. φ is a variable that takes on the value 1) unity in the continuity equation, 2) \vec{u}u, v, w in the momentum equation, and 3) e in the heat equation. The four terms in the equation represent, respectively, the rate of change of the quantity in the control volume, due to convective flux, diffusive flux, and volumetric source. Equation [1] can thus be expressed in any of these forms which are then employed simultaneously to solve problems involving heat, momentum, and mass transfer. In the work reported here, only the continuity and momentum forms were employed.

To solve these equations, the package transforms the model into a system of discrete equations. Each discretized equation is then solved iteratively using the semi-implicit method for pressure linked equations (SIMPLE) algorithm, in which initial values are assigned to variables, then continuously re-calculated for small time intervals dt until a desired tolerance and convergence is reached.

A_{C}φ_{C}+Σ_{K}A_{K}φ_{K}=Q_{C} [2]

where Q is the final scalar calculated, c is the center cell, and k is a neighboring cell.

Once a CAD model is imported into Star-CCM+, both the surface and volume may be meshed. Meshing may accomplish two goals: it may reveal errors in the geometry that may have been generated during CAD drawing, and it may increase the accuracy of the final solution by discretizing the geometry into increments as small as desired. Specifically, surface meshing may allow for precise calculations at the boundaries of the 3D model, while volume meshing allows for precise calculations throughout the body of the model. Because the size of the models considered in this work measure several centimeters, a mesh base size is specified, or length of an edge of a mesh element, that ranges from 0.5 mm to 1 mm. With the Star-CCM+ feature of ‘target mesh size,’ this specification leads to a finalized mesh size of approximately 0.075 mm. For a 1 mm³ cube, this specification yields approximately 2370 volume mesh elements and 1066 surface mesh elements.

After a mesh has been successfully completed, the flow conditions may be specified to define the problem. For an ultrafilter with blood plasma as the fluid, the following conditions may be taken:

1) Laminar flow

2) Steady-state operation

3) Constant fluid density: 1025 kg/m3

4) Constant fluid viscosity: 8.89E-3 Pascal-seconds

5) Three-dimensional flow

6) Segregated flow

The surface geometry of the end-cap CAD model was partitioned into three regions: wall region, inlet surface, and outlet surface. At the inlet, a mass flow rate of 5.125E-4 kg/s is specified, which is calculated by converting the volumetric flow rate of 30 cm3/min using the plasma density of 1025 kg/m3. For the wall region, a no-slip condition may be specified; this wall region is effectively the entire wetted area of the end-cap, and excludes the exterior portions of the actual end-cap. Within the end-cap, there is an inwardly protruding dimple which has a desired effect of forcing the incoming plasma flow toward the fibers. Finally, the outlet is taken as the plane where the cap meets the dialyzer fibers, with an outlet flow rate of 5.125E-4 kg/s. Through previous trial runs, it was determined that a practical method of correctly representing several thousand fiber openings is to partition the outlet into segments (1 through 9) as illustrated in FIG. 9 in which each segment is allocated a percentage of the total outlet flow in proportion to the area. The segments can be pie-shaped arcs segments or other shapes of partitions from circles.

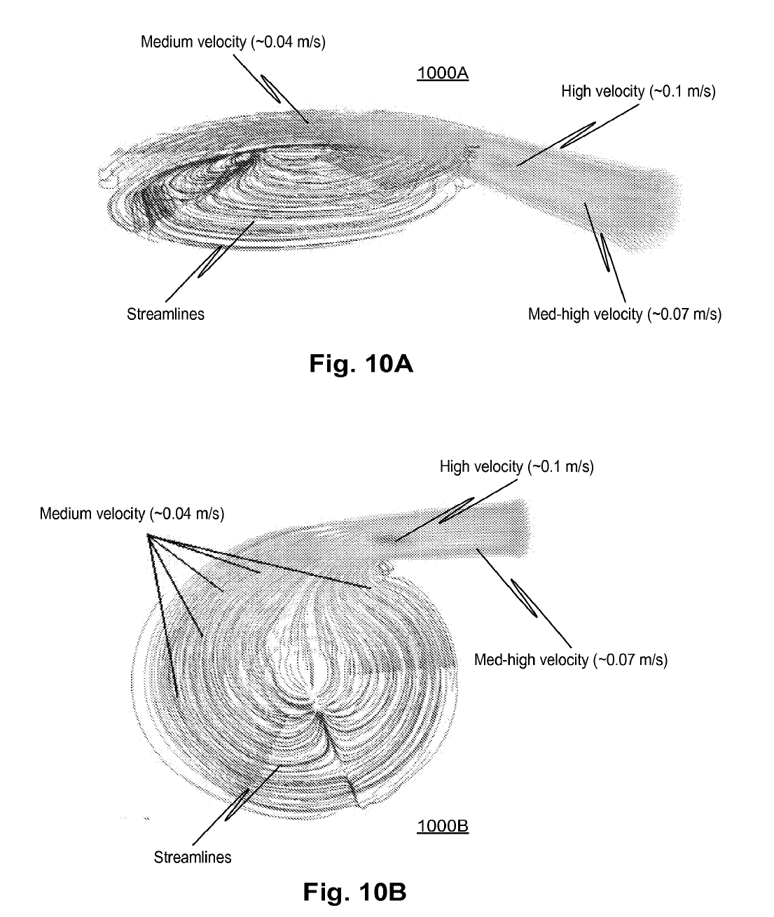

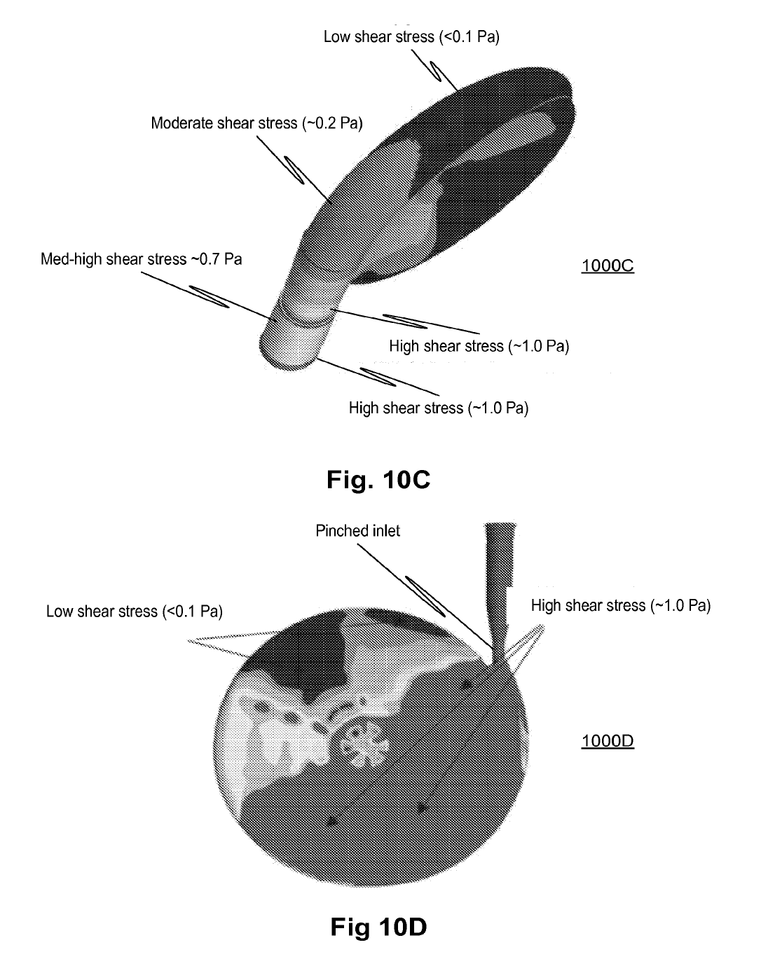

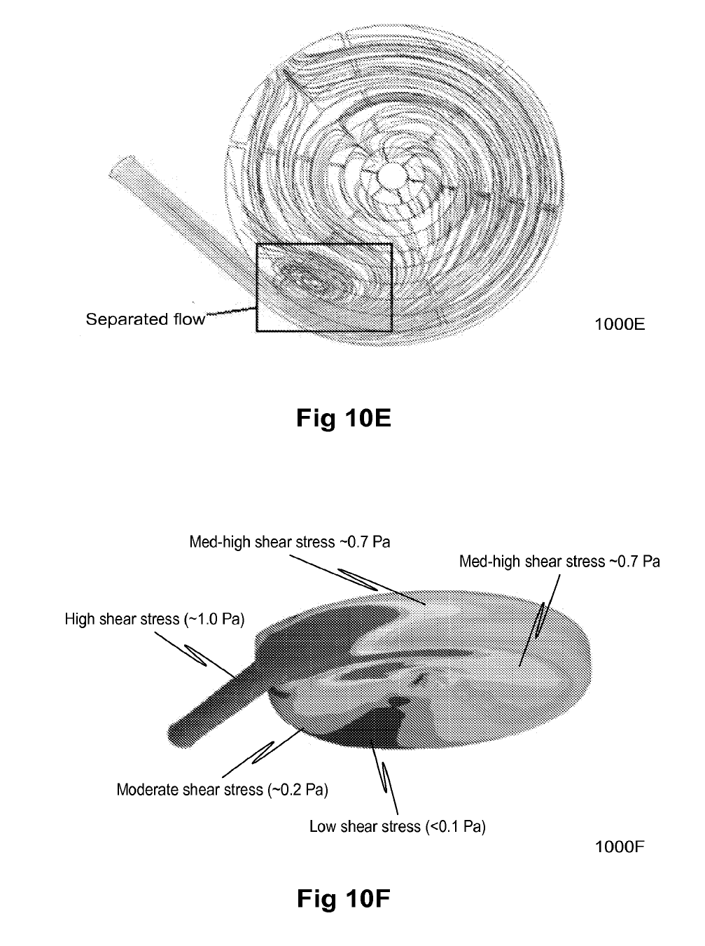

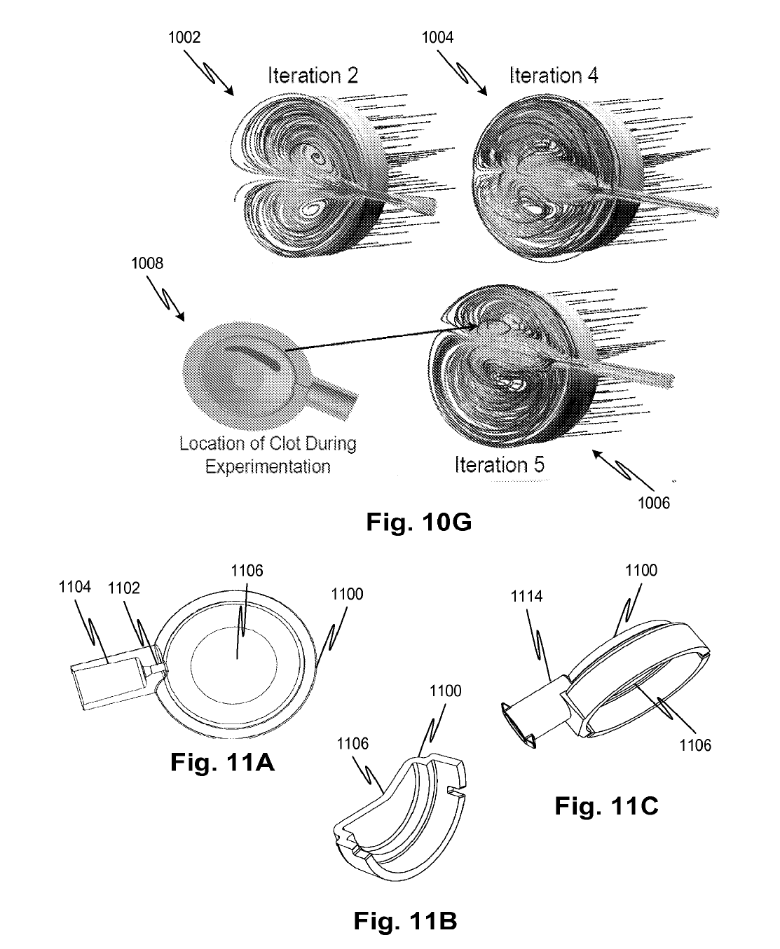

FIGS. 10A through 10G illustrate results of CFD simulations and experimental validation and confirmation for various end cap configurations according to embodiments of the disclosed subject matter.

FIGS. 10A and 10B show velocity data including regions of high velocity and streamlines for a tangential-entry embodiment, shown from perspectives 1000A and 1000B, with an approximately conical end cap. As may be observed, the clearance in the space and the velocities are such that momentum effects do not prevent the flow from making sharp turns and the flow is essentially potential or viscous in nature. Also, the flow velocity varies over an order of magnitude as indicated by labeling. FIG. 10C shows shear data on the same configuration showing also a large range of variation for this configuration.

A pinched entry point as shown in FIG. 10D provided a more uniform shear rate distribution. However, flow separation similar to what is shown in FIG. 10E was observed. FIGS. 10E and 10F show a design with a more tangential entry than the embodiments of FIGS. 10A through 10D.

A few embodiments are shown in FIG. 10G; labeled Iteration 2 1002, Iteration 4 1004, and Iteration 5 1006. Iteration 2 1002 has a radial side entry. Iteration 4 1004 has a midplane side entry. Iteration 5 1006 has an offset central entry (partly tangential and partly radial). Iteration 2 revealed shear rate peaking toward the middle but formed a better distribution than other designs, but low shear rate was indicated at the rear. Iteration 5 1006 shows low shear rate where clot formation were observed in experiment as indicated at 1008, showing the location of the clot as a dark smear. This coincided with CFD prediction of low shear rate.

Referring to FIGS. 11A to 11C, a filter cap 1100 based on Iteration 5 1006 discussed above has an inlet 1102 that is offset relative to the axial center (located at the apex of the inverted cone 1106) of the head space. A port 1104 permits attachment of tubing.

In all of the above embodiments, the shear rate at the wetted surfaces of the head space may be between 100 sec⁻¹ and 2000 sec⁻¹. In all of the above embodiments, the shear rate at the wetted surfaces of the head space may be between 200 sec⁻¹ and 2000 sec⁻¹. In all of the above embodiments, the shear rate at the wetted surfaces of the head space may be between 400 sec⁻¹ and 2000 sec⁻¹. These minimum shear rates are particularly challenging to achieve in the context of very low flow rates as for example in long term plasma or blood cleansing system, such as low flow rate wearable systems. Examples of low flow rate systems are ones where the flow of fluid through the membrane filter are less than about 100 cc/min or below. Systems may also exist with flow rates of less than about 50 cc/min. Systems may also exist with flow rates of 10 cc/min or less. For example, a wearable system (running continuously to treat end stage renal failure) which separates plasma from whole blood and flows only the plasma through the membrane filter may have rates lower than 50 cc/min or even less than 10 cc/min of plasma through the membrane filter. Systems conforming to the description of FIG. 8 are further described (and the details hereby incorporated by reference herein) in U.S. patent application Ser. No. 12/759,157, filed 13 Apr. 2010.

The foregoing merely illustrates the principles and examples of the disclosed subject matter. Various modifications and alterations to the described embodiments will be apparent to those skilled in the art in view of the teachings herein. It will thus be appreciated that those skilled in the art will be able to devise numerous systems and methods which, although not explicitly shown or described herein, embody the principles of the disclosed subject matter and are thus within the spirit and scope of the present invention.

1-45. (canceled)

46. A filter device, comprising:
a microfiber filter type filter with a bundle of tubular membrane channels housed within a body and connected at first and second ends of the body with an interior chamber within the body, the tubular membrane channels extending between the first and second ends of the body and opening into head spaces at the first and second ends;
at least one cap, at the first end, the at least one cap defining a first of the head spaces;
the tubular membrane channels opening to the head space through a first major face thereof, the openings of the tubular membrane channels extending over a region from the middle of the major face toward a perimeter of the major face,
the cap having a port, a distribution channel configured to be fed by the port, the channel opening to the head space at a perimeter thereof such that a fluid flowing into the port may enter the head space at the perimeter and exit through the tubular membrane channels;
the head space having a second major face opposite the first, at least one of the first and second faces being shaped such that the head space has a decreasing gap between the first and second major faces along a radial direction.

47. The device of claim 46, wherein the first major face has a conical shape with the apex at a center of the second major face.

48. The device of claim 46, wherein the distribution channel has a progressively decreasing cross-sectional area from a proximal end located at the port to a distal end thereof.

49. The device of claim 46, wherein the distribution channel is at all points of its axial extent open to the head space.

50. The device of claim 46, wherein the cap has an inlet slit connecting the circumferential channel to the head space.
